(19) United States
(12) Patent Application Publication
(10) Pub. No.: US 2009/0326697 A1
(43) Pub. Date: Dec. 31, 2009

(54) SEMICONDUCTOR MANUFACTURING AUTOMATION SYSTEM AND METHOD FOR USING THE SAME

(75) Inventors: Zhe Xu, Suzhou (CN); Ming-Chun Peng, Suzhou (CN)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: HEJIAN TECHNOLOGY (SUZHOU) CO., LTD., Suzhou (CN)

(21) Appl. No.: 12/556,571

(22) Filed: Sep. 10, 2009

Related U.S. Application Data
(63) Continuation-in-part of application No. 11/560,837, filed on Nov. 17, 2006.

(51) Int. Cl. G06F 17/50; G06F 19/00

(52) U.S. Cl. 700/103; 700/121; 700/107

(57) ABSTRACT

A semiconductor manufacturing automation system for automatically manufacturing a plurality of semiconductor products by using a plurality of tools is provided. The system comprises a database, a receiver module, a data retriever and a data loading module. The database stores a plurality of manufacturing recipes with respect to the semiconductor products respectively. Each of the manufacturing recipes records at least one of the tools for manufacturing the corresponding semiconductor product and a plurality of parameters for controlling each of the tools for manufacturing the corresponding semiconductor product. The receiver module is used for receiving a request for manufacturing one of the semiconductor products. The data retriever is used for retrieving one of the recipes from the database according to the request. The data loading module is used for automatically loading the retrieved recipe to the corresponding tools.

### CROSS-REFERENCE TO RELATED APPLICATION

This application is a continuation-in part application of Ser. No. 11/560,837, filed on Nov. 17, 2006, now pending. The entirety of the above-mentioned patent application is hereby incorporated by reference herein and made a part of specification.

### BACKGROUND OF THE INVENTION

1. Field of the Invention

The present invention generally relates to an electronic frame data management system (eFDMS), and more particularly to a semiconductor manufacturing automation system and method for using the same.

2. Description of Related Art

For over a half century, integrated circuit (IC) design has gone from the invention of the first solid-state transistor to today's multi-million transistor circuits. Accommodating this remarkable evolution of circuit design is the electronic design automation (EDA) industry. From the driving forces of fierce competition to the adherence to Moore's Law, the EDA industry has provided many technological innovations covering a multitude of disciplines. From the invention of hardware definition languages (HDL), to the extension of the marketable life of the semiconductor exposure systems, the EDA industry has continued to evolve to meet the ever-increasing semiconductor industry demands. Productivity, quality, and efficiency have become the main driving forces behind the various improvements in EDA, and especially in the “design-to-manufacturing” technologies relating to frame data management in semiconductor manufacturing automation.

Referring to FIG. 1, a conventional method for managing photomask recipe data in, for example, GDS file format, includes the following steps: First, in step S100, after a mask is fabricated for the lithography mask-making, all of the data are stored under a text file and in an attachment file format on a web page for a web portal at the workstation without having a saved backup copy. Next, in step S102, a user may manually download a plurality of photomask recipe data in the form of a text file using the web portal, and the downstream user may use the data contained in the above text file by searching and data transferring manually line-by-line. Next, in step S104, a downstream user using the photomask recipe data as a text file during the setting up of a new recipe for the workstation would encounter data entry errors, thereby leading to inaccuracies or discrepancies in the setting up of operating settings for mask-making.

In step S106, after the recipe is established at a workstation, if it is desired to inspect or change the current recipe settings, one may perform manual queries or data entry at a user interface at the workstation, wherein accidental inadvertent input errors may likely occur. Next, in step S108, the manual inputting of recipes into a workstation requires a substantial amount of time, which typically takes about 7 to 8 minutes per recipe, and also lacking reusability for the inputted product recipes. Next, in step S110, Upon an update of the product recipe, all of the historical data for the mask-making (including both new and old) will be stored under a selected product recipe, and a user may occasionally make inadvertent errors such as the inputting of the “old” recipe data, which is an older incorrect replaced-version.

### SUMMARY OF THE INVENTION

Accordingly, at least one objective of the present invention is to provide a semiconductor manufacturing automation system capable of increasing the production efficiency.

At least another objective of the present invention is to provide a method for automatically manufacturing a semiconductor product capable of decreasing the possibility to re-work the semiconductor product.

To achieve these and other advantages and in accordance with the purpose of the invention, as embodied and broadly described herein, the invention provides a semiconductor manufacturing automation system for automatically manufacturing a plurality of semiconductor products by using a plurality of tools. The semiconductor manufacturing automation system comprises a database, a receiver module, a data retriever and a data loading module. The database stores a plurality of manufacturing recipes with respect to the semiconductor products respectively. Each of the manufacturing recipes records at least one of the tools for manufacturing the corresponding semiconductor product and a plurality of parameters for controlling each of the tools for manufacturing the corresponding semiconductor product and a plurality of the masks used with the tools respectively for manufacturing the corresponding semiconductor product. The receiver module is used for receiving a request for manufacturing one of the semiconductor products. The data retriever is used for retrieving one of the recipes with respect to the requested semiconductor product from the database according to the request. The data loading module is used for automatically loading the retrieved recipe to the corresponding tools for manufacturing the requested semiconductor product.

According to one embodiment of the present invention, the semiconductor manufacturing automation system further comprises a plurality of terminal machines. Each of the terminal machines has a web interface for collecting a plurality of new parameters with respect to the corresponding tool for manufacturing the request semiconductor products and inputting the new parameters into the database.

The present invention further provides a method for automatically manufacturing a semiconductor product by using a database. The database stores a plurality of manufacturing recipes with respect to the semiconductor products respectively, each of the manufacturing recipes records at least one of the tools for manufacturing the corresponding semiconductor product and a plurality of parameters for controlling each of the tools for manufacturing the corresponding semiconductor product and a plurality of the masks used with the tools respectively for manufacturing the corresponding semiconductor product. The method comprises receiving a request for manufacturing a first semiconductor product and retrieving one of the recipes with respect to the first semiconductor product from the database according to the request. Then, the retrieved recipe is automatically loaded to the corresponding tools for manufacturing the first semiconductor product.

According to one embodiment of the present invention, the method further comprises collecting a plurality of new parameters with respect to the corresponding tool for manufacturing the first semiconductor products through a plurality of terminal machines. Each of the terminal machines has a web interface for receiving the new parameters. Then, the new parameters are inputted into the database through the web interface.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart illustrating the conventional method for the use and management of a photomask recipe data.

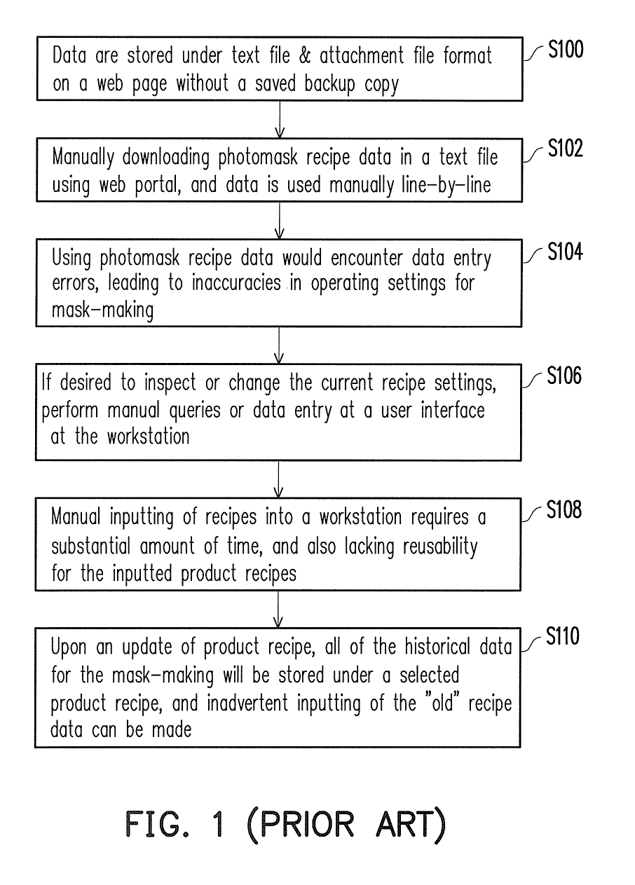

FIG. 2 is a block diagram illustrating an eFDMS for semiconductor manufacturing automation system, according to a first embodiment of the present invention.

FIG. 3 is a flow chart illustrating a method for implementing eFDMS for semiconductor manufacturing automation, according to the first embodiment of the present invention.

FIG. 4 is a flow chart illustrating a method for implementing eFDMS for semiconductor manufacturing automation, according to a second embodiment of the present invention.

FIG. 5 is a general process flow diagram for illustrating the range of operations available at a photo portal, according to a third embodiment of the present invention.

FIG. 6 illustrates a process flow for implementing a WAT portal for the eFDMS for semiconductor manufacturing automation, according to a fourth embodiment of the present invention.

FIG. 7 illustrates a method for performing layer-by-layer accuracy verifications of the input process settings in the eFDMS, according to the third embodiment of the present invention.

FIG. 8 is a schematic diagram showing a semiconductor manufacturing automation system according to one embodiment of the present invention.

FIG. 9 is a schematic diagram showing a semiconductor manufacturing automation system according to another embodiment of the present invention.

FIG. 10 is a schematic diagram showing a database used in a semiconductor manufacturing automation system according to one embodiment of the present invention.

### DETAILED DESCRIPTION OF THE EMBODIMENTS

The present invention will now be described with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

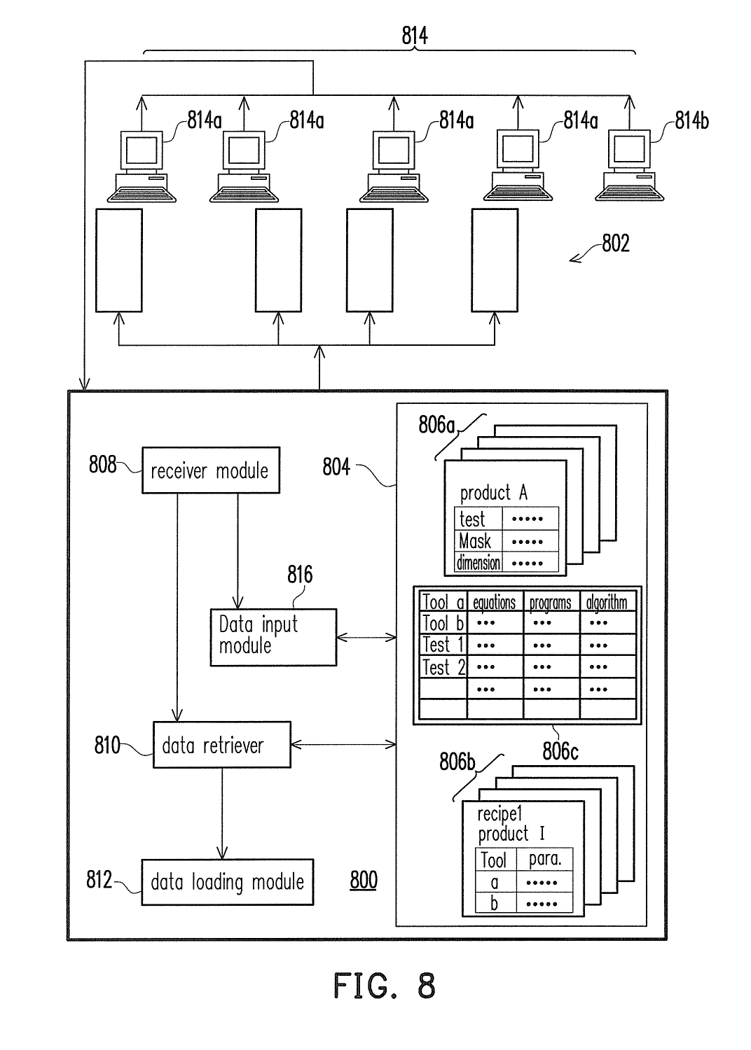

The present invention provides a semiconductor manufacturing automation system. FIG. 8 is a schematic diagram showing a semiconductor manufacturing automation system according to one embodiment of the present invention. As shown in FIG. 8, the semiconductor manufacturing automation system 800 is used for automatically manufacturing a plurality of semiconductor products by using a plurality of tools 802. The tools 802 comprise the photolithography machines or any machine used in the manufacturing procedure for forming a semiconductor product.

The semiconductor manufacturing automation system 800 comprises a database 804. In one embodiment, the aforementioned database can be a relational database such as a structure-query-language based database (SQL database). The database 804 comprises a plurality of data. The data are classified according to the product types. The data can be, for example but not limited to, the metrology information of a photomask and the photomask is used for manufacturing a specific manufacturing level of material layer. The data also can be, for example but not limited to, the metrology information of a semiconductor product and the semiconductor product is manufactured by using the aforementioned photomask. The data further can be, for example but not limited to, the testing information, such as the wafer acceptance test (WAT) result, of the semiconductor product which is manufactured by using the aforementioned photomask and the testing point and the testing designs of the semiconductor product. The data, hereafter, may be rephrased as the product data without changing the definition of the data mentioned above.

In one embodiment of the present invention, the data are classified and recorded into several data pages 806a (as shown in FIG. 8) according to the semiconductor products and each of the pages store the specification of the specific semiconductor product, the specification of the photomasks for manufacturing the specific semiconductor product and the testing information of the semiconductor product manufactured by using the photomasks. The specification of the specific semiconductor product includes metrology information such as the critical dimension, the line width, pitch size and/or feature size of the specific semiconductor product. The testing information of the semiconductor product comprises the coordinates of the testing points and the testing designs of the specific semiconductor product and the WAT result of the specific semiconductor product. Further, the specification of the photomasks for manufacturing the specific semiconductor product includes metrology information of the photomasks such as the critical dimension, the line width and the pitch size of the main pattern on the photomask and the dimensions and the coordinates of the dummy patterns on the photomask. It should be noticed that the data/the product data stored in the database and classified according to the semiconductor products are nothing but the raw data directly obtained from simply measuring the dimensions of the semiconductor products and the photomasks for manufacturing the semiconductor products and from the testing information (coordinates of the testing points and the testing designs) and the testing information of the semiconductor products.

In another embodiment of the present invention, the database 804 stores a plurality of manufacturing recipes 806b. Each of the manufacturing recipes 806b is used for manufacturing one of the semiconductor products. Furthermore, each of the manufacturing recipes 806b records at least one of the tools 802 for manufacturing the corresponding semiconductor product. Moreover, each of the manufacturing recipes 806b records a plurality of parameters for controlling each of the tools 802 for manufacturing the corresponding semiconductor product and each of the manufacturing recipes 806b further records a plurality of the photomasks used with the tools 802 respectively for manufacturing the corresponding semiconductor product. Furthermore, each of the recipes also records the necessary operation equations, programs and algorithms for calculating the parameters in manufacturing the semiconductor product. It should be noticed that, the parameters, operation equations, programs and algorithms for the different tool combinations for manufacturing the same semiconductor product are also detail records in each of the recipes.

Furthermore, the database 804 further stores a plurality of system operation tools such as operation equations, programs and the algorithms (as shown in the data page 806c) used in various tools for manufacturing the semiconductor products and for implementing the WAT testing.

The semiconductor manufacturing automation system 800 also comprises a receiver module 808, a data retriever 810 and a data loading module 812. The receiver module 808 is used for receiving a request for manufacturing one of the semiconductor products. The data retriever 810 is used for retrieving one of the recipes with respect to the requested semiconductor product from the database 804 according to the request. The data loading module 812 is used for automatically loading the retrieved recipe to the corresponding tools for manufacturing the requested semiconductor product.

The semiconductor manufacturing automation system 800 further comprises a plurality of terminal machines 814. In one embodiment of the present invention, the terminal machines 814a are equipped with a corresponding tool 802. In another embodiment of the present invention, the terminal machines, such as the one labeled 814b, can be also the end terminal computers at leas one of which can communicate at least one of the tools 802. In one embodiment of the present invention, each of the terminal machines 814 may collect a plurality of new parameters with respect to the corresponding tool 802 for manufacturing the request semiconductor products and/or collect a plurality of the product data with respect to the corresponding semiconductor products and inputting the new parameters and/or the product data into the database 804. In addition, the semiconductor manufacturing automation system 800 comprises a data input module 816 for inputting the new parameters and/or the collected product data into the database 804 after the new parameters and/or the product data are received by the receiver module 808.

In one embodiment of the present invention, once the user confirms to manufacture a semiconductor product and the semiconductor manufacturing automation system of the present invention acknowledges the product information such as the product ID (identification number or identity) in a form of a manufacturing request received by the receiver module 808, one of the recipes with respect to the semiconductor product is retrieved from the database according to the request by the data retriever 810. After the recipe with respect to the semiconductor product to-be-manufactured is retrieved, the recipe is automatically loaded to the corresponding tools 802 for manufacturing the semiconductor product.

Furthermore, if the tools are adjusted by new parameters during the manufacturing procedure of the semiconductor product, the new parameters are automatically or manually collected by the terminal machines corresponding to the tools respectively and are inputted into the database 804. In one embodiment, for each of the terminal machines, it is installed with a web interface for user to easily collect the new parameters for manufacturing the semiconductor products.

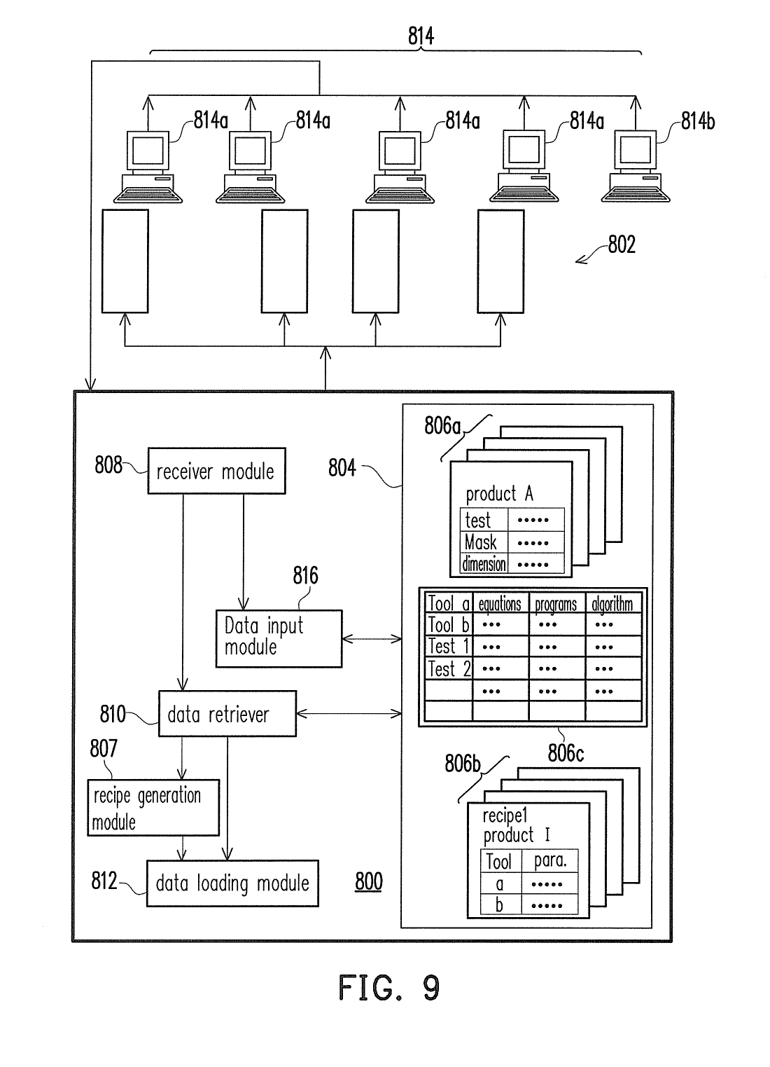

In another embodiment of the present invention, the semiconductor manufacturing automation system 800 further comprises a recipe generation module 807 as shown in FIG. 9. Once the user allocates at least one specific tool 802 to manufacture a semiconductor product and the semiconductor manufacturing automation system of the present invention acknowledges the product information such as the product ID and the tool information such as the tool ID in a form of a manufacturing request received by the receiver module 808 from at least one of the terminal machines 814, the recipe generation module generates a recipe for manufacturing the product on the at least one specific tool 802 according to the product ID and the tool ID in the manufacturing request. It should be noticed that, in the present exemplary embodiment of the present invention shown in FIG. 9, the data retriever 810 retrieves the product data according to the product ID from the data pages 806a in the database 804 and the retrieved product data are calculated in the recipe generation module 807 to generate the recipe for manufacturing the semiconductor product according to the manufacturing request. Furthermore, the recipe generation module 807 calculates the retrieved product data by using the operation equations, programs and the algorithms, which are related to the manufacturing and/or testing of the semiconductor product and are also retrieved by the data retriever 810 from the data page 806c in the database 804 according to the product ID or the tool ID. After the recipe with respect to the semiconductor product to-be-manufactured is generated, the recipe is automatically loaded to the allocated tools 802 for manufacturing the semiconductor product. In one embodiment, the generated recipe can be also stored as a data page of the data pages 806b in the database 804 by the data input module 816.

In the present invention, since the recipes for manufacturing the semiconductor products are stored in the database and the parameters of the tools, the operation equations, programs and the algorithms are stored according to the semiconductor products, once the user issues the request for manufacturing a particular semiconductor product, the semiconductor manufacturing automation system can automatically retrieves the related recipe from the database and load the recipe to the tools for manufacturing the particular semiconductor product. Alternatively, in the present invention, the recipe for manufacturing the semiconductor products can also be automatically generated by the recipe generation module 807 using the retrieved product data and the retrieved operation equations, programs and algorithms according to the manufacturing request. Hence, once the user allocates at least one tool for manufacturing a particular semiconductor product, the semiconductor manufacturing automation system can automatically generates the related recipe and load the recipe to the tools for manufacturing the particular semiconductor product.

Therefore, it is not necessary for the user to individually adjust each of the tools on the product line for manufacturing the semiconductor product. Accordingly, the error because of the manually inputting or adjusting the tools can be avoided and the possibility for re-working the semiconductor product can be decreased. Furthermore, the time for user to individually review the manufacturing information of the semiconductor product can be saved and the production efficiency is increased.

Moreover, in one embodiment, in the database, the recipe for manufacturing a photomask is integrated with the testing information of the semiconductor product which is manufactured by using the photomask. Therefore, information from the manufacturing line and the testing result stored under the same product category can give the user a more clear picture for manufacturing the semiconductor product. Further, since the recipe corresponding to the semiconductor product detail records the parameters for controlling the tools and the operation equations, programs and algorithms for applying the parameters, the user can easily access the database to obtain the manufacturing information about the semiconductor product through a simple user interface of the semiconductor manufacturing automation system.

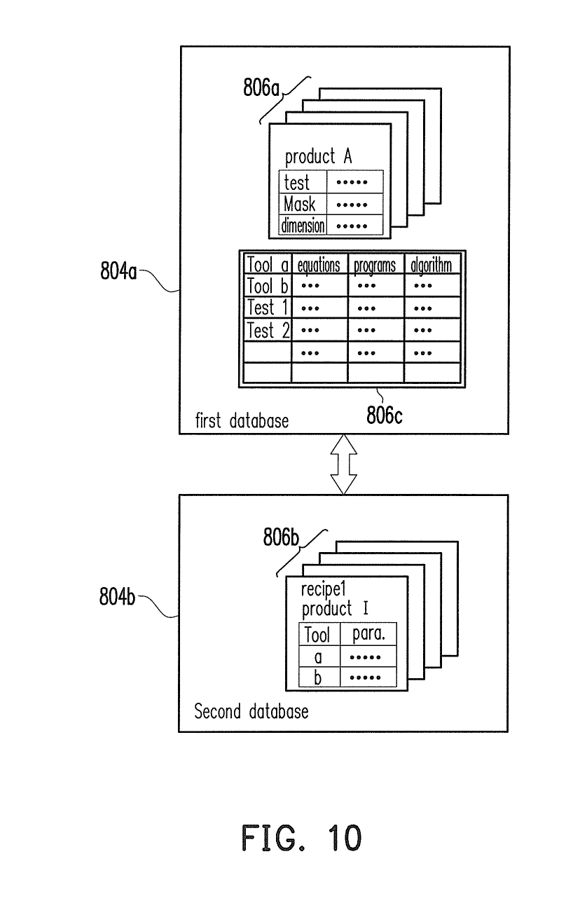

In addition, in another embodiment of the present invention shown in FIG. 10, the database 804 can be implemented by combining several sub-database for storing the data pages 806a, 806b and 806c respectively. In FIG. 10, the data pages 806a related to the product data and the data page 806c recording the operation equations, programs and the algorithms used in the tools for manufacturing the semiconductor products and the testing program are stored in a first database 804a. Furthermore, the data pages 806b, each of which is a recipe for manufacturing a specific semiconductor product, are stored in a second database 804b. For the sakes of the convenience and the security, the first database 804a can be configured in a server and the second database 804b can be configured in the other server such as a web-server and the first database 804a in the server can be only accessed by the web-server and the host computer. Therefore, the product data and the related information including operation equations, programs and the algorithms can only be changed or modified under authorization or by the authorized user and will not be damaged or changed by easily log-in from the terminal machines. Moreover, the first database 804a in the server can be synchronized with the second database 804b in the web-server in a predetermined time interval. In one embodiment of the present invention, the data synchronization between the first database 804a and the second database 804b can be implemented by replicating the data in the first database 804a into the second database 804b. Therefore, users can communicate with the web-server by using the web interface installed in the terminal machines 814 to receive the recipe under the manufacturing request from the web-server without further accessing the data in the first database 804a. Furthermore, the receiver module 808, the data input module 816, the data retriever module 810, the data loading module 812 and the recipe generation module 807 of the semiconductor manufacturing automation system 800 of the present invention can be also configured in the web-server so that not only accessing the required recipes from the data pages 806b can be implemented in the web-server but also generating the recipe under the request can be done by the web-server.

Followings are several embodiments for describing the present invention. In the drawings, whenever the same element reappears in subsequent drawings, it is denoted by the same reference numeral.

For the sake of convenience of understanding, some key terms are first presented.

A “web portal” is a webpage in a web browser such as Internet Explorer™, Netscape™ Navigator®, Netscape Browser™, Opera™, Mozilla™, Mozilla Firefox™, etc. . . . , an Adobe™ Flash®_page, or an Adobe™ Shockwave® page with a display portion and a user-executable portion.

A “server” is a web server, an application server, a peer-to-peer server, a database server, a mobile server, a proxy server, a redirect server, or any other similar types of devices capable of handling the necessary functionalities required by the eFDMS.

A “workstation” is a computer, a lap top, a device with at least a processor, a display, and memory, a desktop, a mainframe, a PDA, a blackberry type device, a server, a web host, or any other similar types of wired or wireless networked device capable of performing the functions required under the eFDMS.

An “application program” is defined as a software program, a java applet, a Java application, an activeX control object, a Javascript object, a Vbscript object, a Microsoft® ASP.NET web service, or any other similar types of software objects capable of providing one or more functionalities.

A “main program” is defined as a software program, a java bean, a Microsoft® ASP.NET web service, or any other fully functional software solutions which are capable of managing, interacting, and supporting a plurality of workstations and servers for the eFDMS systems.

A “database” is defined as a collection of logically related data designed to meet the information needs of one or more users, and including commercial and noncommercial databases such as Oracle® database, Microsoft® Access™, Microsoft® SQL Server, MySQL® database, PostgreSQL, Ingres®, Firebird® database, Berkeley DB Java Edition, SQLite, IBM® Informix™ database, and other similar systems.

As used herein, the words “may” and “may be” are to be interpreted in an open-ended, non-restrictive manner. At minimum, “may” and “may be” are to be interpreted as definitively including structure or acts recited.

An eFDMS system according to the first through the fifth embodiments of the present invention may be utilized in a semiconductor foundry for integrating the mask making, the photolithography exposure, and the WAT testing processes to form an integrated automated production system in EDA.

The three production processes mentioned above, namely the mask making process, the photolithography exposure process, and the WAT testing process for the foundry in the IC Semiconductor industry typically will use the same system; therefore, the eFDMS system may be used interchangeably.

According to the first through the fifth embodiments of the present invention, the main functions of the eFDMS includes the following: mask making data management, mask making data searching/querying, and mask making data usage.

According to the first through the fifth embodiments of the present invention, the web portal may include any one or more of the following in any conceivable combinations: a photo portal for access by the photolithography department or personnel (during normal use); a WAT portal for access by the WAT department or personnel (during normal use); and a mask house portal for access by the mask shop (all functionalities for the mask shop involves connecting between the internet and the company intranet in which the mask house portal may typically remain in idle status).

According to the first through the fifth embodiments of the present invention, the display screens for displaying the web portal are arranged in a manner that deliver data to the workstation in a form that permits the workstation to generate appropriate instructions for a particular production order. The display screens have various interface features which are familiar to persons who use windows-type operating systems. These features or graphical user interfaces include data entry boxes, pull down menus, selection buttons, and scroll bars.

### First Embodiment

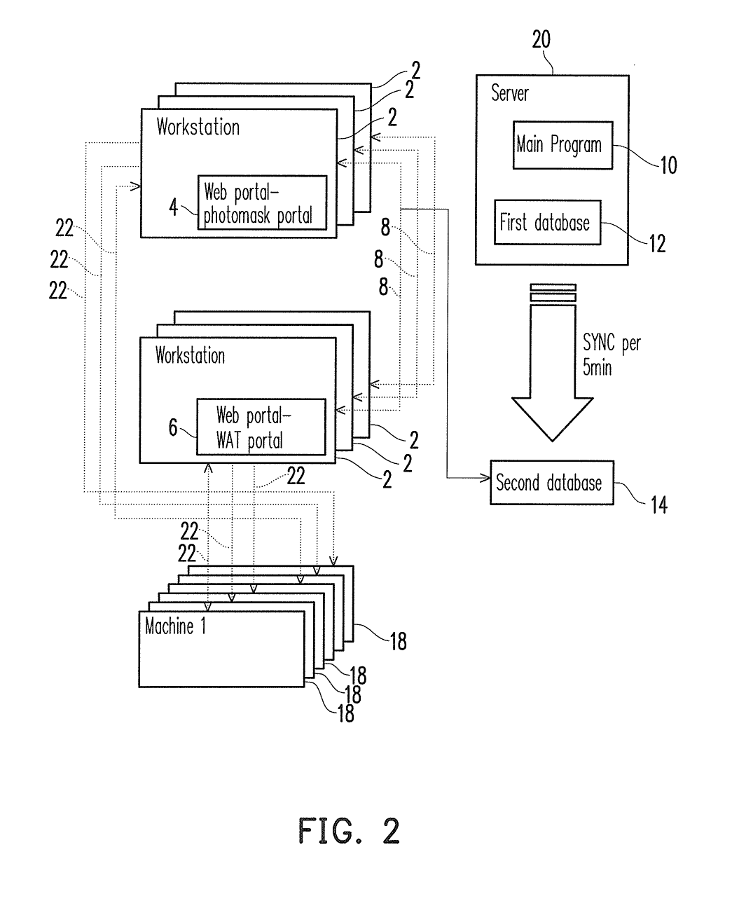

Referring to FIG. 2, an eFDMS for semiconductor manufacturing automation according to a first embodiment of the present invention includes a plurality of workstations 2, a plurality of web portals 4, 6 which are comprised of a plurality of photomask portals 4 and/or a plurality of WAT portals 6, one or more servers 20, a plurality of machines 18, and a main program 10 residing on one or more servers 20.

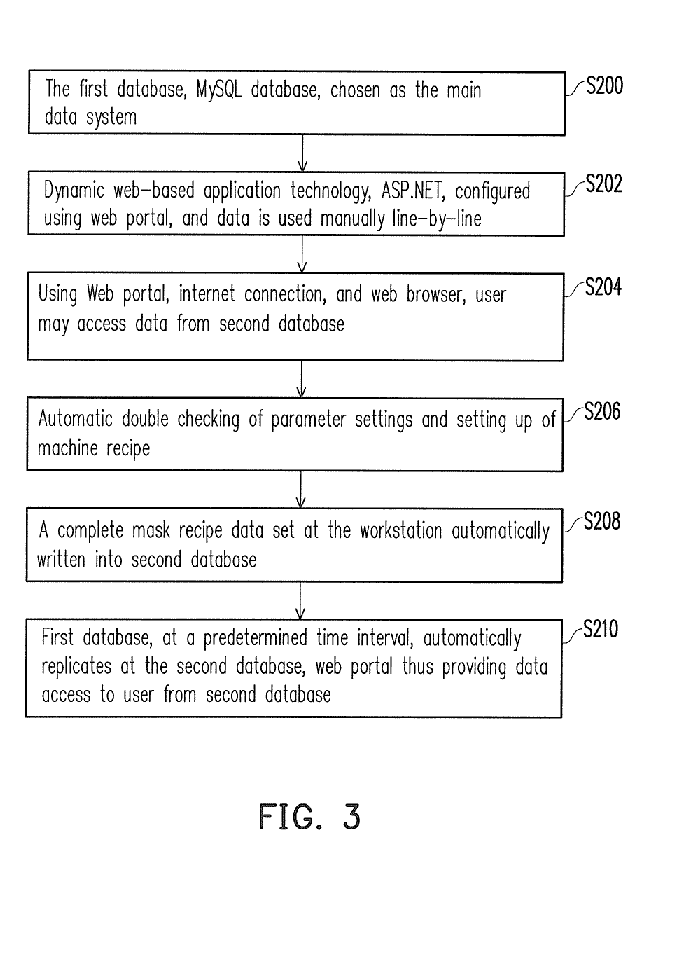

Referring to FIG. 3, a flow chart illustrating a method for implementing the electronic frame data management system (eFDMS) for semiconductor manufacturing automation, according to the first embodiment of the present invention, comprising of the following steps: First, in step S200, the first database, such as a MySQL database, having a high degree of data stability, ease of use, and proper scalability, is chosen as the main data system. Next, in step S202, a dynamic web-based application technology, such as ASP.NET technology, is configured for taking the data from the first database, the MySQL database, to provide access to the user at each of the workstation. Next, in step S204, using a web portal, an internet connection, and a web browser, the user (without having to install any additional software) is able to access the data from the second database, such as a Microsoft SQL database, which has improved usability, workflow efficiency, product quality, and service quality.

In step S206, automatic double checking of parameter settings and setting up of machine recipe are implemented. Next, in step S208, a complete mask recipe data set at the workstation is automatically written into the second database, such as the Microsoft SQL database. Next, in step S210, the first database, the MySQL database, at a predetermined time interval of, for example, 5 minutes, takes its stored data to be automatically replicated at the second database, the Microsoft SQL database, thus allowing a web portal using ASP.NET technology to process the data from the second database, the Microsoft SQL database, via the web portal to provide access to the user.

### Second Embodiment

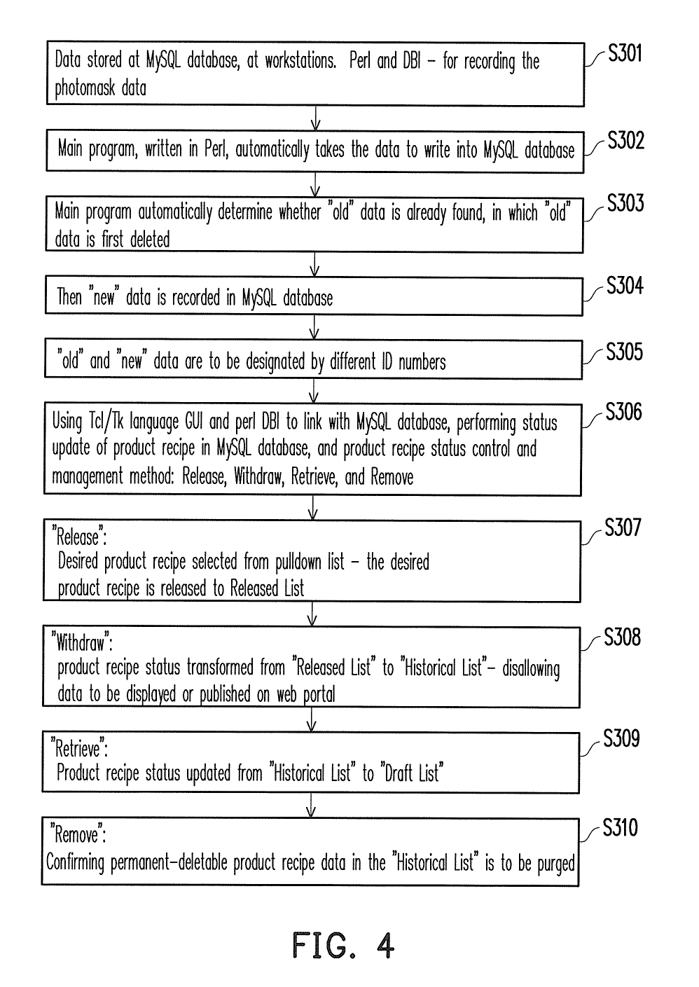

Referring to FIG. 4, a method for implementing eFDMS for photolithography processes for semiconductor manufacturing automation, according to a second embodiment of the present invention includes the following:

### 1. Data Management

A database interface language such as Perl DBI is used. Perl DBI is a database independent interface for Perl. The Perl DBI and the Perl programming language is a standard API. DBI defines a set of parameters, variables, and uniform database interface, which can fulfill the needs for the eFDMS. Perl is the abbreviation for Practical Extraction and Report Language. Furthermore, programming for the eFDMS may be performed under UNIX environment.

First, in step S301, a plurality of data are stored at a first database, a MySQL database, at a workstation such as a photolithography workstation and a photomask making workstation (using UNIX system). Perl and DBI are utilized for recording the photomask data into the first database, the MySQL database. Next, in step S302, programming is performed under UNIX environment. After the mask is made, a main program, which may be written in perl, automatically takes the data to write into the first database, the MySQL database. Next, in step S303, when writing data, the main program may automatically determine whether “old” data is already found in the first database, in which the “old” data in the first database is first deleted. Next, in step S304, then the “new” data is recorded in the first database, and in step S305, the “old” and “new” data for the product recipe in the MySQL database, respectively, are to be designated by different ID numbers for ease of data management.

### 2. Product Recipe Status Control and Management

In step S306, using Tcl/Tk language GUI in UNIX and connecting with the perl DBI to link with the first database, the MySQL database, for performing status update of a plurality of product recipes in the MySQL database in the workstation, a product recipe status control and management system includes at least four functions, namely Release, Withdraw, Retrieve, and Remove, as shown below:

### “Release” Function:

In step S306, the product recipe data is listed in all of the Draft List in the MySQL database and the desired product recipe is selected from the pulldown list upon selecting “(1) Read From File”; “(2) Select the product” is entered,”; and finally “(3) Release to transform the product to the Released List.” is selected.

### “Withdraw” Function:

In step S308, the product recipe status is transformed from a “Released List” to a “Historical List”, thereby disallowing the data to be displayed or published on the web portal.

### “Retrieve” Function:

In step S309, the product recipe status is updated from the “Historical List” to a “Draft List”.

### “Remove” Function:

In step S310, the confirmed permanent-deletable product recipe data in the “Historical List” is purged from the first database and the second database.

### Third Embodiment

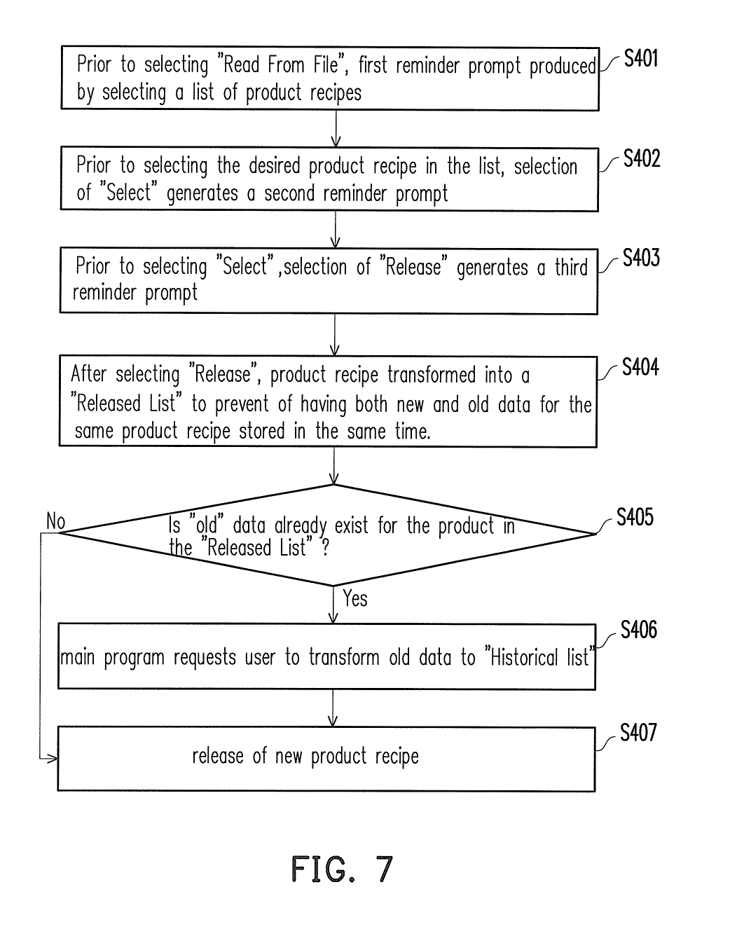

Referring to FIG. 7, a method for performing layer-by-layer accuracy verifications of the input process settings or for error proofing during data entry is included in the main program for implementing the eFDMS, according to a third embodiment of the present invention. The aforementioned method which is applicable for use in a Product Release GUI, a Product Withdraw GUI, a Product Retrieve GUI, and a Product Remove GUI, for ensuring that a correct pre-established order of entry at the web portal are followed, is described as follows: First, in step S401, prior to selecting “Read From File”, a first reminder prompt is produced by selecting a list of saved product recipes. Next, in step S402, prior to selecting the product recipe in the list, the selection of “Select” generates a second reminder prompt. Next, in step S403, prior to selecting the “Select”, the selection of the “Release” generates a third reminder prompt.
1. In step S404, after selecting the “Release”, the product recipe is taken to be transformed into a “Released List” to prevent having both new and old data for the same product recipe stored in the “Released list” at the same time while releasing a product recipe, and in step S405 whether “old” data already exists for the product recipe in the “Released List” is to be determined; and if the answer is found to be YES, in step S406, the main program then requests the user to take the old data to be transformed to a “Historical list”, after which, in step S407 the release of the new product recipe data is permitted. And if the answer is found to be NO, in step S407, the new product recipe data is permitted also without transforming old data to “Historical list”.
2. The above steps 1 to 3 are applicable for use in the Product Release GUI, the Product Withdraw GUI, the Product Retrieve GUI, and the Product Remove GUI.

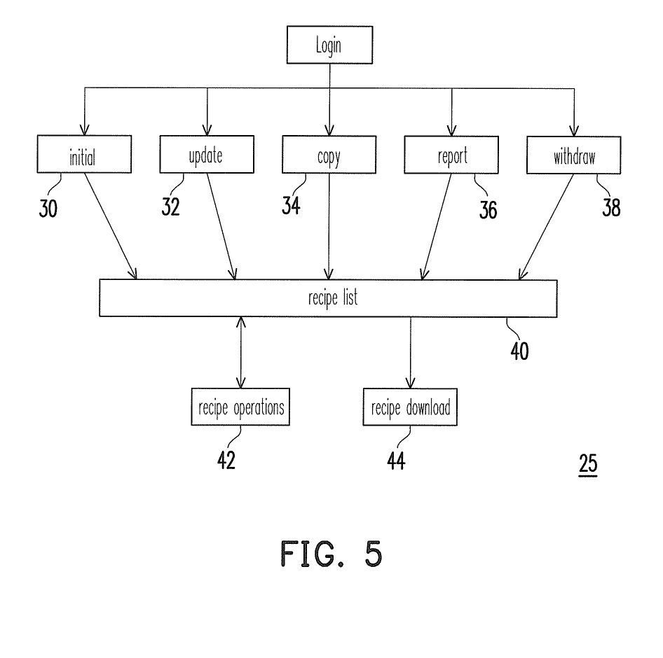

Referring to FIG. 5, a photo portal 25 comprises a range of functions using a plurality of menu buttons, namely an initial button 30, an update button 32, a copy button 34, a report button 36, and a withdraw button 38. The photo portal 25 is further comprising of a recipe list 40, a plurality of recipe operations 42, and a recipe download function 44.

A photo portal 25 may include an item called “PU Type” according to the third embodiment of the present invention. When one of the various different PU Types is selected, such as, for example, KSCAN, ILSTEP, OLSTEP, a product recipe having different formats may be generated and stored in the first database, the user is able to download the desired product recipe in a report page in the web portal to provide to the workstation for use.

### Fourth Embodiment

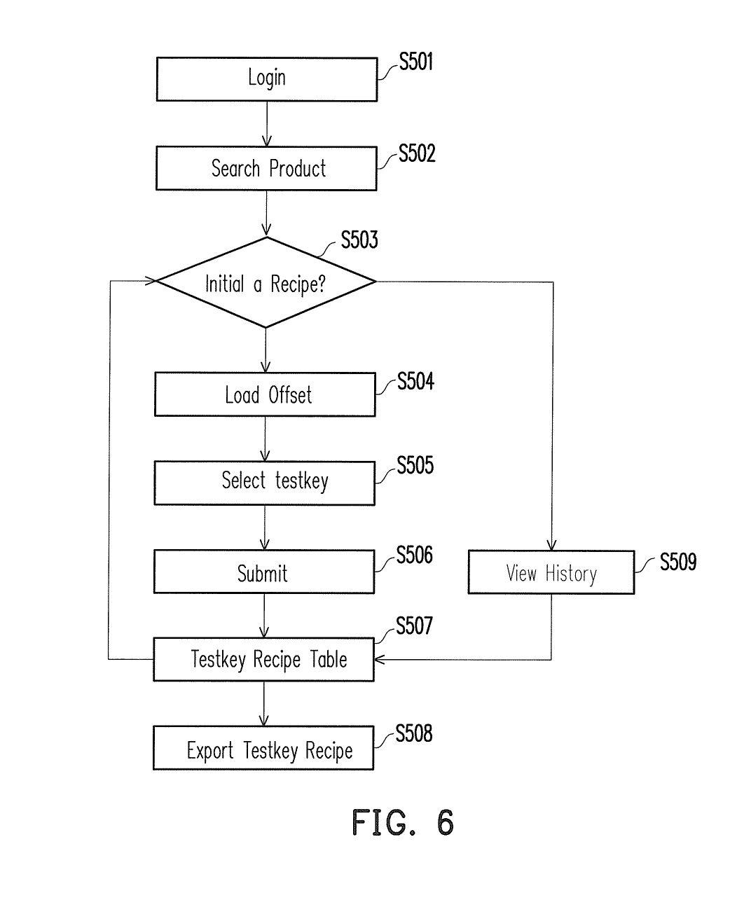

Referring to FIG. 6, a process flow for implementing a WAT portal for the eFDMS for semiconductor manufacturing automation, according to a fourth embodiment of the present invention, comprise of the following steps: First, in step S501, login is commenced. Next, in step S502, searching a desired product recipe. Next, in step S503, initializing a product recipe by pressing the “initial” button. Next, in step S504, loading a map shot offset by pressing the “load” button. Next, in step S505, selecting a plurality of testkeys. Next, in step S506, pressing the “submit” button. Next, in step S507, completing & viewing a testkey recipe table. Next, in step S508, viewing a historical list of textkey history and in step S509, exporting a WAT product recipe in a spreadsheet file format, such as, an EXCEL file format.

### Fifth Embodiment

According to a fifth embodiment of the present invention, approximately 30˜40 layers of photomasks, wherein each layer of photomask is to require one product recipe, are used for a production run for a particular product. As a result, 30˜40 recipes are produced in the fifth embodiment. The eFDMS method as implemented on 30˜40 recipes is able to save between 40% to 60% of the amount of set up time as compared to when using a manual method. According to the fifth embodiment of the present invention, it may only require about 3 hours to set up the 30˜40 recipes. In addition, additional shortened cycle time may also be realized by downstream users for not having to double check the recipe settings.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A semiconductor manufacturing automation system for automatically manufacturing a plurality of semiconductor products by using a plurality of tools, comprising:
a database storing a plurality of manufacturing recipes with respect to the semiconductor products respectively, wherein each of the manufacturing recipes records at least one of the tools for manufacturing the corresponding semiconductor product and a plurality of parameters for controlling each of the tools for manufacturing the corresponding semiconductor product and a plurality of the masks used with the tools respectively for manufacturing the corresponding semiconductor product;
a receiver module for receiving a request for manufacturing one of the semiconductor products;
a data retriever for retrieving one of the recipes with respect to the requested semiconductor product from the database according to the request; and
a data loading module for automatically loading the retrieved recipe to the corresponding tools for manufacturing the requested semiconductor product.

2. The semiconductor manufacturing automation system of claim 1 further comprising a plurality of terminal machines, wherein each of the terminal machines has a web interface for collecting a plurality of new parameters with respect to the corresponding tool for manufacturing the request semiconductor products and inputting the new parameters into the database.

3. The semiconductor manufacturing automation system of claim 1, wherein the database further stores a plurality of product data and system operation tools, and the request specifies at least a first tool of the tools for manufacturing the requested semiconductor product.

4. The semiconductor manufacturing automation system of claim 3, further comprising a recipe generation module for generating a new recipe by using the product data and the system operation tools in the database according to the specified first tool.

5. A method for automatically manufacturing a semiconductor product by using a database, wherein the database stores a plurality of manufacturing recipes with respect to the semiconductor products respectively, each of the manufacturing recipes records at least one of the tools for manufacturing the corresponding semiconductor product and a plurality of parameters for controlling each of the tools for manufacturing the corresponding semiconductor product and a plurality of the masks used with the tools respectively for manufacturing the corresponding semiconductor product, the method comprising:
receiving a request for manufacturing a first semiconductor product;
retrieving one of the recipes with respect to the first semiconductor product from the database according to the request; and
automatically loading the retrieved recipe to the corresponding tools for manufacturing the first semiconductor product.

6. The method of claim 5 further comprising:
collecting a plurality of new parameters with respect to the corresponding tool for manufacturing the first semiconductor products through a plurality of terminal machines, wherein each of the terminal machines has a web interface for receiving the new parameters; and
inputting the new parameters into the database through the web interface.

7. The method of claim 5, wherein the database further stores a plurality of product data and system operation tools, and the request specifies at least a first tool of the tools for manufacturing the first semiconductor product.

8. The method of claim 7, further comprising generating a new recipe by using the product data and the system operation tools in the database according to the specified first tool.
